(19) United States
(12) Patent Application Publication
(10) Pub. No.: US 2009/0103281 A1
(43) Pub. Date: Apr. 23, 2009

(54) BACKLIGHT DEVICE AND DISPLAY DEVICE

(75) Inventor: Hideki Koh, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/065,519

(22) PCT Filed: Jul. 4, 2006
(86) PCT No.: PCT/JP2006/313316

§ 371 Date: Mar. 3, 2008

(30) Foreign Application Priority Data
Sep. 5, 2005 (JP) 2005-256617

(51) Int. Cl. F21V 19/00

(52) U.S. Cl. 362/97.1; 362/225

(57) ABSTRACT

In a backlight device, lamp units including cold cathode-ray tubes (straight-tube lamp portions) and inverter circuits (driving circuits) for driving to switch on the cold cathode-ray tubes are arranged along a direction that is substantial perpendicular to a longitudinal direction of the cold cathode-ray tubes. Further, the inverter circuits of the lamp units are disposed separately on one end portion side and other end portion side in the longitudinal direction of the cold cathode-ray tubes. Thereby, even when using the longitudinal cold cathode-ray tubes, brightness on a light emitting surface can be made uniform.

### BACKGROUND OF THE INVENTION

1. Field of the Invention

The present invention relates to a backlight device having a plurality of straight-tube lamps (linear light sources) and a display device using the same.

2. Description of the Related Art

Recently, for example, liquid crystal display devices have been used widely for liquid crystal television sets, monitors, mobile phones and the like, as flat panel displays having features of small thickness, light weight and the like, compared with conventional Braun tubes. Such a liquid crystal display includes an illumination device (backlight device) that emits light and a liquid crystal panel that displays desired images by functioning as a shutter with respect to the light from a light source provided in the backlight device.

Moreover, the backlight devices are classified into direct types and edge-light types according to the arrangement of the light source with respect to the liquid crystal panel. For the liquid crystal display device provided with the liquid crystal panel with a size of 20 inches or more, the direct type backlight device whose brightness and size can be increased more easily than the edge light type is generally used. That is, the direct type backlight device is structured to dispose a plurality of linear light sources on a back (non-display surface) side of the liquid crystal panel, and the linear light sources can be disposed on the immediate back side of the liquid crystal panel, which enables the use of many linear light sources, so that it is easy to obtain high brightness, thereby being suitable for increasing the brightness and the size. Moreover, the direct type backlight device has a hollow structure inside thereof, and has a light weight even if increasing its size, thereby being suitable for increasing the brightness and the size.

Moreover, the direct type backlight device is provided with a straight-tube lamp constituted of a cold cathode ray tube as the linear light source, and an inverter circuit for driving to switch on the lamp, as described in JP 2002-231034 A, for example. The backlight device outputs light to the liquid crystal panel in a flat shape (hereinafter, called “planar light”) from a light emitting surface that is arranged to face the liquid crystal panel.

Moreover, it is suggested to reduce the size and the cost of the above-described conventional backlight device, that is, the liquid crystal display, by simplifying a structure of an electric circuit of the lamp. More specifically, in this conventional backlight device, one inverter circuit is connected with one of electrode portions of each pair of the lamps that are disposed at a predetermined interval, and the inverter circuit drives each pair of the lamps, thereby decreasing the number of the inverter circuits provided. Further, in this conventional backlight device, a plurality of the inverter circuits are disposed gathering on one end portion side in a longitudinal direction of the lamp, thereby simplifying a wiring structure of the lamp, reducing the sizes of the backlight device and the liquid crystal display and saving the cost.

However, the above-described conventional backlight device may cause problems in that non-uniformity of the brightness is generated on the light emitting surface and the brightness on the light emitting surface is difficult to be made uniform.

More specifically, in the conventional backlight device, since a power source is supplied from one of the electrode portions that is connected with the inverter circuit to each lamp, the one electrode portion of each lamp that is near from the inverter circuit is a high voltage side, and the other electrode portion of each lamp that is spaced away from the inverter circuit is a low voltage side. Further, in order to increase a light utilizing efficiency of each lamp, a reflecting plate made of a metal is provided on an opposite side of the light emitting surface of each lamp, and a leak current is generated according to a parasitic capacity that is present in a lamp peripheral portion between each lamp and the reflecting plate or the like. Thus, in each lamp, a brightness inclination occurs, where a current flowing inside the lamp is decreased as a distance from the inverter circuit is increased, and the brightness is degraded accordingly. As a result, in the longitudinal direction of each lamp, a difference between the brightness of the high voltage side and the brightness of the low voltage side is increased, whereby the non-uniformity of the brightness appears on the light emitting surface. In particular, according to the increase of the screen size of the liquid crystal display, when using a longitudinal lamp with an extended dimension in the longitudinal direction, the conventional backlight device cannot suppress an influence of the non-uniformity of the brightness due to the brightness inclination in each lamp to appear significantly on the light emitting surface, and it was difficult to make uniform the brightness on the light emitting surface.

### SUMMARY OF THE INVENTION

In the light of the problems described above, preferred embodiments of the present invention provide a backlight device and a display device that can make uniform the brightness on a light emitting surface, even when using a longitudinal lamp.

A backlight device according to a preferred embodiment of the present invention includes: a plurality of straight-tube lamp portions; and a lamp unit having a driving circuit that is connected with each of high voltage sides of the plurality of the straight-tube lamp portions and drives to switch on each of the straight-tube lamp portions, and wherein a plurality of the lamp units are arranged along a direction that is substantially perpendicular to a longitudinal direction of the straight-tube lamp portions, and driving circuits of the plurality of the lamp units are disposed separately on one end portion side and another end portion side in the longitudinal direction of the straight-tube lamp portions.

In the backlight device structured as described above, since the driving circuits of the plurality of the lamp units are disposed separately on the one end portion side and the other end portion side in the longitudinal direction of the straight-tube lamp, the high voltage sides of the straight-lamp portions of the lamp units are distributed to the one end portion side and the other end portion side, thereby preventing concentration of the high voltage sides of the straight-tube lamp portions to one of the one end portion side and the other end portion side. As a result, unlike the above-described conventional example, even when the longitudinal lamp is used for each straight-tube lamp, the influence of the non-uniformity of the brightness due to the brightness inclination in each of the straight-tube lamp portions can be decreased, so that the brightness on the light emitting surface can be made uniform.

Moreover, in the backlight device, it is preferable that the number of the driving circuits provided on the one end portion side in the longitudinal direction of the straight-tube lamp portion is equal to the number of the driving circuits provided on the other end portion side in the longitudinal direction.

In this case, the high voltage sides of the straight-tube lamp portions of the lamp units are disposed separately in the same number on the one end portion side and the other end portion side in the longitudinal direction of the straight-tube lamp portion, and the influence of the non-uniformity of the brightness due to the brightness inclination is decreased, whereby the brightness on the light emitting surface can easily be made uniform.

Moreover, in the backlight device, it is preferable that the driving circuits of the plurality of the lamp units are disposed alternately on the one end portion side and the other end portion side in the longitudinal direction, in a direction that is substantially perpendicular to the longitudinal direction of the straight-tube lamp portions.

In this case, in the plurality of the lamp units, the influences of the non-uniformity of the brightness due to the brightness inclinations can be canceled out more reliably in the direction substantially perpendicular to the longitudinal direction of the straight-tube lamp portion, whereby the brightness on the light emitting surface can be easily made uniform.

Moreover, in the backlight device, it is also preferable that the driving circuits on each of the one end portion side and the other end portion side in the longitudinal direction of the straight-tube lamp portion are disposed on a single substrate, respectively.

In this case, operations for integrating the driving circuits into the backlight device can be simplified. Moreover, since the single substrate is used on each of the one end portion side and the other end portion side, a supporting structure in the backlight device can be simplified, and the number of the constituent elements of the device can be reduced, so that the backlight device which can be assembled easily at a low cost can be provided.

Moreover, in the backlight device, it is preferable that the plurality of the straight-tube lamp portions include N (N is an integer of 1 or more) pairs of the straight-tube lamp portions that are driven by driving signals from the driving circuits, which have equal amplitudes and phases that are opposite to each other.

In this case, in each of the N pairs of the straight-tube lamp portions, each of the straight-tube lamps can be driven to be switched on without grounding the low voltage sides, thus structuring the backlight device with a small number of constituent elements using the lamp units that can be constructed easily. Moreover, since the respective straight-tube lamp portions are driven to be switched on by driving signals that are the same and have phases deviated by 180°, it is possible to cancel out (electrostatic) noises by mutual interference of the driving signals at the time of lighting and stabilize a lighting state of each of the straight-tube lamp portions so as to prevent the degradation of the light emitting efficiency.

Moreover, in the backlight device, it is also possible that each of the pair of the straight-tube lamp portions includes a high voltage side electrode that is connected with the driving circuit and a low voltage side electrode that is disposed facing to the high voltage side electrode, and the one pair of the straight-tube lamp portions are a pseudo U-shaped tube obtained by connecting the low voltage side electrodes of the one pair of the straight-tube lamp portions with each other via a connection wiring provided externally.

In this case, it is possible to structure the backlight device having excellent efficiencies of utilizing the light from the straight-tube lamp portions.

Moreover, in the backlight device, it is possible that a cold cathode-ray tube is used for each of the plurality of the straight-tube lamp portions, and each of the straight-tube lamp portions is disposed so that a longitudinal direction thereof is substantially parallel with a direction that is substantially perpendicular to the gravitational direction.

In this case, it is possible to structure the straight-tube lamp portions having excellent light emitting efficiencies, thus structuring the backlight device with the suppressed power consumption and the high brightness easily. Moreover, in the cold cathode-ray tube, mercury (vapor) enclosed therein can be prevented from being concentrated to one of the end portion sides in the longitudinal direction due to the gravitational effect, so that the lives of the straight-tube lamp portions can be increased significantly.

Moreover, a backlight device according to a preferred embodiment of the present invention is a display device including a display portion, wherein the display portion is irradiated with light from any of the above-described backlight devices.

In the display device structured as described above, even when a longitudinal lamp is used, the display portion is irradiated with the light from the backlight device that can make uniform the brightness on the light emitting surface, so that it is possible to easily structure the display device that can prevent the degradation of display quality on the display portion and has an excellent display performance, even when increasing the screen size.

Preferred embodiments of the present invention provide a backlight device that easily makes uniform the brightness on the light emitting surface even when using a longitudinal lamp, and a display device including such a backlight device.

These and other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a schematic cross-sectional view explaining a backlight device and a liquid crystal display device according to first preferred embodiment of the present invention.

FIG. 2 is a plan view showing an arrangement of lamp units that are provided in the backlight device.

FIG. 3 is a block diagram showing a specific driving circuit of the lamp unit.

FIG. 4 is a plan view showing an arrangement of lamp units in the backlight device according to a second preferred embodiment of the present invention.

### DETAILED DESCRIPTION OF THE PREFERRED EMBODIMENTS

Preferred embodiments of the backlight device and the display device of the present invention will be explained below with reference to the drawings. Incidentally, a case of applying the present invention to a transmission type liquid crystal display device will be exemplified in the below explanation. However, the present invention is not limited thereto.

### First Preferred Embodiment

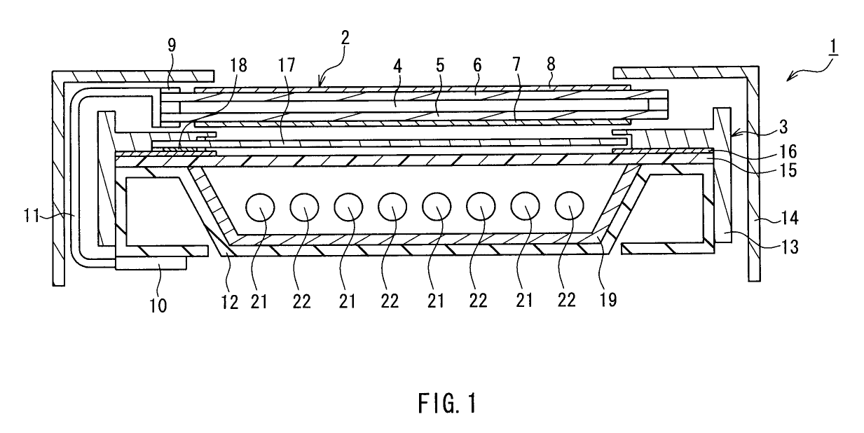

FIG. 1 is a schematic cross-sectional view illustrating a backlight device and a liquid crystal display device according to a first preferred embodiment of the present invention. In the figure, the liquid crystal display device 1 of the present preferred embodiment is provided with a liquid crystal panel 2 as a display portion, which is disposed so that its visible side (display surface side) is the upper side in the figure, and a backlight device 3 of the present preferred embodiment that is disposed on a non-display surface side of the liquid crystal panel 2 (the lower side of the figure) and generates illumination light for illuminating the liquid crystal panel 2.

The liquid crystal panel 2 is provided with a liquid crystal layer 4, a pair of transparent substrates 5 and 6 that sandwich the liquid crystal layer 4, and polarizing plates 7 and 8 that are provided on outer surfaces of the transparent substrates 5 and 6, respectively. Moreover, the liquid crystal panel 2 is provided with a driver 9 for driving the liquid crystal panel 2, and a driving circuit 10 that is connected with the driver 9 via a flexible print substrate 11. And, the liquid crystal panel 2 is structured so that it can drive the liquid crystal layer 4 by each pixel. Then, in the liquid crystal panel 2, a polarizing plate of the above-described illumination light that is incident via the polarizing plate 7 by the liquid crystal layer 4 is modulated, and an amount of light to pass through the polarizing plate 8 is controlled, thereby displaying a desired image.

The backlight device 3 is provided with a case 12 with a bottom that has an opening on the upper side of the figure (the liquid crystal panel 2 side), and a frame 13 shaped like a framework that is disposed on the liquid crystal panel 2 side of the case 12. Moreover, the case 12 and the frame 13 are preferably made of metals or synthetic resins, which are interposed between bezels 14 preferably having L-shaped cross sections in a state where the liquid crystal panel 2 is disposed above the frame 13. Thereby, the backlight device 3 is incorporated into the liquid crystal panel 2, and is integrated into the transmission type liquid crystal display device 1 that allows the illumination light from the backlight device 3 to be incident into the liquid crystal panel 2.

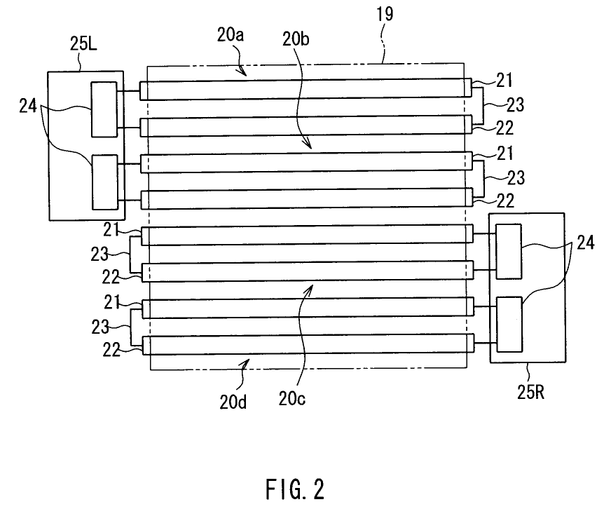

Moreover, the backlight device 3 is provided with a diffusing plate 15 that is disposed so as to cover the opening of the case 12, an optical sheet 17 that is disposed on the liquid crystal panel 2 side above the diffusing plate 15, and a reflecting sheet 19 that is provided inside the case 12. Moreover, by referring to FIG. 2, the backlight device 3 is provided with, for example, four lamp units 20a, 20b, 20c and 20d above the reflecting sheet 19. Each of the lamp units 20a to 20d preferably includes cold cathode-ray tubes 21 and 22 as a pair of straight-tube lamp portions, and light from these cold cathode-ray tubes 21 and 22 is output as the above-described illumination light from a light emitting surface of the backlight device 3 that is disposed facing the liquid crystal panel 2.

The diffusing plate 15 is preferably made of a substantially rectangular synthetic resin or glass material having a thickness of, for example, about 2 mm, diffuses the light from the cathode-ray tubes 21 and 22 (including the light reflected by the reflecting sheet 19), and outputs the light toward the optical sheet 17 side. Moreover, the diffusing plate 15 is mounted on a surface of a framework whose four sides are provided above the case 12, and is incorporated into the backlight device 3 in a state of being interposed between the surface of the case 12 and an inner surface of the frame 13 by intervening a pressurizing member 16 that can be deformed elastically. Further, in the diffusing plate 15, a substantial central portion of the diffusing plate 15 is supported by a transparent supporting member (not illustrated) that is disposed on the reflecting sheet 19 so as to be prevented from being bent toward the inside of the case 12.

Moreover, the diffusing plate 15 is held so that it can be moved between the case 12 and the pressurizing member 16, and even when expansion deformation (plasticity deformation) of the diffusing plate 15 occurs due to influences of heat such as heating of the cold cathode-ray tubes 21 and 22 and an increase of a temperature inside the case 12, the plasticity deformation is absorbed due to an elastic deformation of the pressurizing member 16, thereby preventing the degradation of the diffusing property of the light from the cold cathode-ray tubes 21 and 22 as much as possible. Moreover, it is more preferable to use the diffusing plate 15 made of a glass material having higher heat resistance than that of a synthetic resin, because warping, yellowing, heat deformation and the like are not likely to occur due to the influences of the heat.

The optical sheet 17 preferably includes a light gathering sheet that is made of a synthetic resin film with a thickness of, for example, about 0.5 mm, thus being structured to increase brightness of the above-described illumination light that illuminates the liquid crystal panel 2. Moreover, on the optical sheet 17, a known optical sheet material such as a prism sheet, a diffusing sheet and a polarizing sheet for increasing display quality of a display surface of the liquid crystal panel 2 is preferably layered appropriately, if necessary. Then, the optical sheet 17 is structured to convert the light that is output from the diffusing plate 15 into planar light having uniform brightness that has a predetermined brightness (for example, 10,000 cd/m²) or more, and allow the light to be incident as the illumination light to the liquid crystal panel 2 side. Incidentally, alternatively to the above description, an optical member such as a diffusing sheet for adjusting a visible angle of the liquid crystal panel 2 may be layered appropriately above the liquid crystal panel 2 (on the display surface side), for example.

Moreover, in the optical sheet 17, a protruding portion that protrudes to the left side of FIG. 1 is formed in a central portion on a left end side of FIG. 1, which becomes an upper side when actually using the liquid crystal display device 1, for example. And, in the optical sheet 17, only the protruding portion is interposed between the inner surface of the frame 13 and the pressurizing member 16 intervening an elastic material 18, and the optical sheet 17 is incorporated into the backlight device 3 in an expandable state. Thereby, the optical sheet 17 can be deformed to be expanded freely with respect to the protruding portion even when the expanding (plastic) deformation occurs due to the influences of the heat effect due to the heating of the cold cathode-day tubes 21 and 22, and is structured so as to prevent the generation of a wrinkle, bending and the like in the optical sheet 17 as much as possible. As a result, the liquid crystal display device 1 can prevent the degradation of the display quality, which is caused by the bending or the like of the optical sheet 17, such as the non-uniformity of the brightness on the display surface of the liquid crystal panel 2 as much as possible.

The reflecting sheet 19 is preferably made of a metal thin film having high light reflectance such as aluminum and silver with a thickness of, for example, about 0.2 mm to about 0.5 mm, and functions as a reflecting plate for reflecting the light from the cold cathode-ray tubes 21 and 22 toward the diffusing plate 15. Thereby, in the backlight device 3, it is possible to reflect the light emitted from the cold cathode-ray tubes 21 and 22 toward the diffusing plate 15 side efficiently so as to increase an efficiency of utilizing the light and the brightness on the diffusing plate 15. Incidentally, alternatively to the above description, it is also possible to use a reflecting sheet material made of a synthetic resin, instead of the metal thin film, and apply, for example, a paint in white or the like that has high light reflectance onto the inner surface of the case 12 so as to allow the inner surface to function as the reflecting plate.

As shown in FIG. 2, each of the lamp units 20a to 20d includes the pair of the cold cathode-ray tubes 21 and 22 that respectively constitute linear light sources, and a connection wiring 23 for connecting these cold cathode-ray tubes 21 and 22 electrically, and a pseudo U-shaped tube that realizes a simulated U-shaped lamp is used. Moreover, each of the lamp units 20a to 20d is provided with an inverter circuit 24 as a driving circuit that is connected with high voltage sides of the respective cold cathode-ray tubes 21 and 22 and drives to switch on the respective cold cathode-ray tubes 21 and 22. In each of the lamp units 20a to 20d, the pseudo U-shaped tube and the inverter circuit 24 are integrated.

Moreover, in the lamp units 20a and 20b, the inverter circuits 24 thereof are disposed on a single substrate 25L that is provided on one end portion side (the left end portion side of FIG. 2) of the cold cathode-ray tubes 21 and 22 in the longitudinal direction. Whereas, the lamp units 20c and 20d, the inverter circuits 24 thereof are disposed on a single substrate 25R that is provided on other end portion side (the right end portion side of FIG. 2) of the cold cathode-ray tubes 21 and 22 in the longitudinal direction. These inverter circuits 24 are disposed so that they and the inverter circuits 24 of the lamp units 20a and 20b are symmetrical with respect to a point.

The cold cathode-ray tubes 21 and 22 are preferably straight-tube fluorescent lamps, and are disposed substantially in parallel with each other at a predetermined interval in the vertical direction of FIG. 2. Moreover, the cold cathode-ray tubes 21 and 22 preferably are fine tubes that have diameters ranging from about 3.0 mm to about 4.0 mm and excellent light emitting efficiencies, and are held inside the case in a state where respective distances from the cold cathode-ray tubes 21 and 22 to the diffusing plate 15 and the reflecting sheet 19 are kept to be predetermined distances by a light source holding member that is not illustrated. Further, the cold cathode-ray tubes 21 and 22 are disposed so that their longitudinal directions are parallel with a direction perpendicular to the gravitational direction. Thereby, in the cold cathode-ray tubes 21 and 22, mercury (vapor) sealed therein is prevented from being condensed to one end portion side of the longitudinal direction due to the action of the gravity, which leads to significant increases of lives of the lamps.

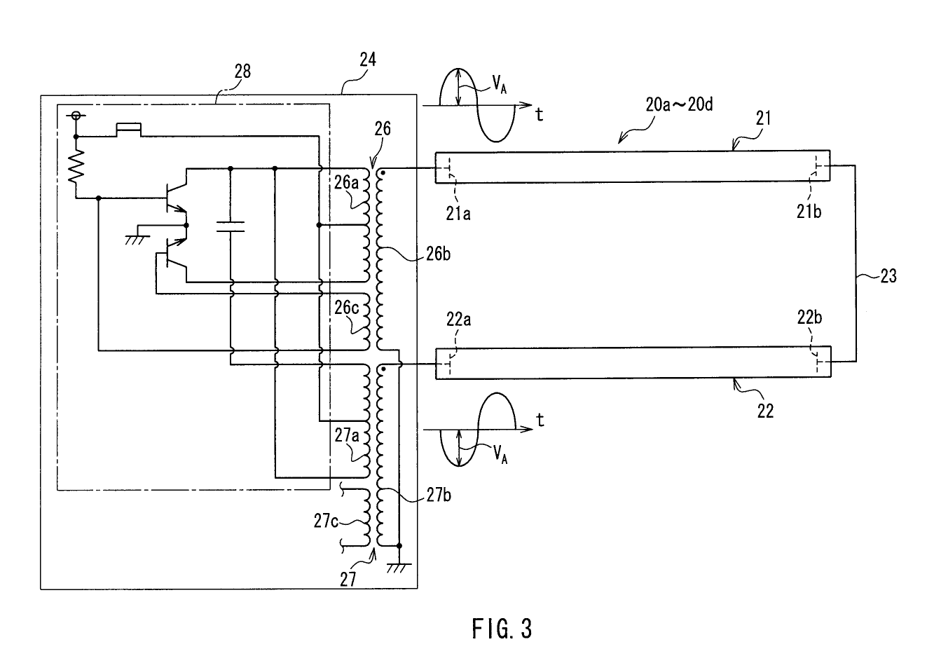

Moreover, as shown in FIG. 3, the cold cathode-ray tubes 21 and 22 are provided with high voltage side electrodes 21a and 22a that are connected with the inverter circuits 24 via connectors (not illustrated), and low voltage side electrodes 21b and 22b that are disposed facing the high voltage side electrodes 21a and 22a. The low voltage side electrodes 21b and 22b are connected with each other via the connection wiring 23 provided outside the lamps, thereby connecting the cold cathode-ray tubes 21 and 22 in series. Further, the cold cathode-ray tubes 21 and 22 are structured so as to perform high frequency lighting according to the driving signals from the inverter circuit 24, and the driving signals having equal amplitudes (VA) and phases that are opposite to each other are synchronized so as to be input into the high voltage side electrodes 21a and 22a. Thereby, in the cold cathode-ray tubes 21 and 22, (electrostatic) noises caused by mutual interference of the driving signals at the time of the lighting operation can be cancelled, so that it is possible to stabilize the state of the lighting the cold cathode-ray tubes 21 and 22 and decrease a level of unwanted irradiation.

The inverter circuit 24 is provided with a first transformer 26 and a second transformer 27 that are the same and output the above-described driving signals respectively to the cold cathode-ray tubes 21 and 22, and a controlling circuit 28 for controlling driving of these transformers 26 and 27. The controlling circuit 28 is structured to include electronic components such as a switching portion using two transistors and a capacitor, as illustrated in FIG. 3, and an IC integrating these electronic components is used as the controlling circuit 28. And, in the inverter circuit 24, the first and second transformers 26 and 27 and the controlling circuit 28 are attached onto the substrates 25L and 25R preferably by soldering, for example.

The respective first and second transformers 26 and 27 are provided with primary wirings 26a and 27a that are connected on the controlling circuit 28 side and secondary wirings 26b and 27b that are connected on the cold cathode-ray tubes 21 and 22 side, respectively. Moreover, a tertiary wiring 26c that is provided in the first transformer 26 is structured so as to function as a base wiring with respect to the above-described switching element of the controlling circuit 28. In the inverter circuit 24, the driving signals that are the same and have phases deviated by 180° are output from the first and second transformers 26 and 27 to the high voltage side electrodes 21a and 22a of the corresponding cold cathode-ray tubes 21 and 22 at the same time.

In the present preferred embodiment structured as described above, the inverter circuits 24 of the lamp units 20a and 20b, among the four lamp units 20a to 20d, are disposed on the substrate 25L that is provided on the one end portion side of the cold cathode-ray tubes 21 and 22 in the longitudinal direction. Moreover, the inverter circuits 24 of the remaining lamp units 20c and 20d are disposed on the substrate 25R that is provided on the other end portion side in the longitudinal direction, so that the high voltage sides (high voltage side electrodes 21a and 22a side) of the cold cathode-ray tubes 21 and 22 of the lamp units 20a to 20d are separated into the one end portion side and the other end portion side, thereby preventing the high voltage sides of the cold cathode-ray tubes 21 and 22 from gathering at one of the one end portion side and the other end portion side. Thereby, in the present preferred embodiment, unlike the above-described conventional example, even when using a longitudinal lamp as each of the cold cathode-ray tubes 21 and 22, it is possible to decrease the influence of the non-uniformity of the brightness due to the brightness inclination in each of the cold cathode-ray tubes 21 and 22, thereby making uniform the brightness of the above-described light emitting surface of the backlight device 3.

Moreover, because of using the backlight device 3 that is capable of making uniform the brightness of the light emitting surface as described above, the degradation of the display quality of the liquid crystal panel (display portion) 2 of the liquid crystal display device 1 of the present preferred embodiment can be prevented even when increasing the screen size, so that it is possible to structure the liquid crystal display device 1 having an excellent display performance easily.

Moreover, in the present preferred embodiment, since the two inverter circuits 24 are disposed on each of the single substrates 25L and 25R, it is possible to simplify an operation of incorporating the inverter circuits 24 into the backlight device 3. Further, compared with the above-described conventional example, in which the plurality of the inverter circuits are disposed gathering to the one end portion side of the longitudinal direction, sizes of the substrates 25L and 25R can be decreased by ½ or less, so that it is possible to simplify a structure of the backlight device 3 for supporting the substrates 25L and 25R. Moreover, it is possible to decrease the number of the members of the backlight device 3 and liquid crystal display device 1, so that it also is possible to structure the backlight device 3 and the liquid crystal display device 1 that can be constructed easily at low costs.

### Second Preferred Embodiment

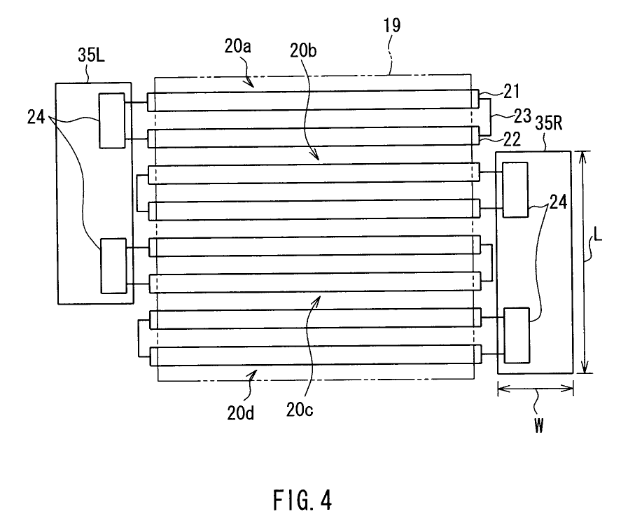

FIG. 4 is a plan view showing an arrangement of lamp units in the backlight device according to a second preferred embodiment of the present invention. In the figure, a main difference between the present preferred embodiment and the first preferred embodiment described above lies in that a plurality of inverter circuits are disposed alternately on one end portion side and other end portion side of the longitudinal direction, in the direction perpendicular to the longitudinal direction of the cold cathode-ray tube. Incidentally, the elements that are common with those in the first preferred embodiment are denoted by the same reference numbers, and the explanations thereof will be omitted.

As shown in FIG. 4, in the present preferred embodiment, on a substrate 35L on a left end portion side of the figure, the inverter circuits 24 of the lamp units 20a and 20c are disposed. Moreover, on the substrate 35R on a right end portion side of FIG. 4, the inverter circuits 24 of the lamp units 20b and 20d are disposed, which are disposed alternately with the inverter circuits 24 of the lamp units 20a and 20c in a direction perpendicular to the longitudinal direction of the cold cathode-ray tubes 21 and 22.

According to the above-described structure, in the present preferred embodiment, similarly to the first preferred embodiment described above, the inverter circuits 24 of the four lamp units 20a to 20d are separated into the one end portion side and the other end portion side in the longitudinal direction of the cold cathode-ray tubes 21 and 22, so that the brightness of the above-described light emitting surface of the backlight device 3 can be made uniform, thereby structuring the liquid crystal display device 1 with an excellent display performance easily. Moreover, in the present preferred embodiment, since the four inverter circuits 24 are disposed alternately on the one end portion side and the other end portion side of the longitudinal direction, in the direction that is substantially perpendicular to the longitudinal direction, the influences of non-uniformity of the brightness due to the brightness inclination can be cancelled out more reliably in the direction substantially perpendicular to the longitudinal direction, so that the brightness on the light emitting surface can be made uniform even more easily than that of the first preferred embodiment.

Moreover, it can be confirmed that, by a prototype manufactured by the inventor of the present application, even in the case of structuring the backlight device 3 for the liquid crystal display device 1 that is provided with the liquid crystal panel 2 having a diagonal size of 37 inches, for example, the single substrates 35L and 35R that are not larger than an acceptable dimension which is determined according to heat or the like by soldering or less can be used. That is, for example, in the case of using a substrate obtained by disposing a print wiring on an epoxy resin, electronic components of an inverter circuit are fixed onto the print wiring by soldering, but the substrate is bent due to heat generated at the time of this fixation, thus it is impossible to use a substrate that is longer than 40 cm. Accordingly, the liquid crystal display device 1 having the diagonal size of 37 inches, which has required at least eight lamp units described above, has needed two or more substrates conventionally.

On the other hand, in the backlight device of the present preferred embodiment, the plurality of the inverter circuits 24 are disposed separately on the one end portion side and the other end portion side of the longitudinal direction, so that the inventor could complete the prototype in which the four inverter circuits 24 are disposed alternately on the substrate 35L and the substrate 35R. More specifically, this prototype can be structured so that a lateral dimension and a vertical dimension of each of the substrate 35L and the substrate 35R that are denoted by “W” and “L” in FIG. 4 are 7.8 cm and 39 cm, respectively, both of which are not more than the above-described acceptable dimension.

It should be noted that the above-described preferred embodiments are all illustrative and not limiting. The technical scope of the present invention is defined by the claims, and all changes within the range of equivalents of the configurations recited therein also are included in the technical scope of the present invention.

For example, the above description has provided the case of applying the present invention to the transmission type liquid crystal display device, but the backlight device of the present invention is not limited to this, and can be applied to various kinds of display devices provided with non-light-emission type display portions that display information such as images and characters by utilizing light of straight-tube lamp portions (linear light sources). More specifically, the backlight device of preferred embodiments of the present invention can be applied preferably to a semi-transmission type liquid crystal display device or a projection type display device such as a rear-projection.

Moreover, alternatively to the above description, the present invention can be used preferably as an X film illuminator for illuminating light to x-ray radiographs, a light box for irradiating light to photographic negatives and the like to obtain clearer visibility, and a backlight device of a light emitting device for lighting sign boards, advertisements that are provided on walls in railroad stations and the like.

Moreover, the above description has provided the case of using the four lamp units that are respectively provided with the one pair of the straight-tube lamp portions, but in the present invention, the number of the lamp units to be provided and the number of the straight-tube lamp portions to be included in each of the lamp units are not limited to the numbers described above, as long as the driving circuit of the plurality of the lamp units are disposed separately on the one end portion side and the other end portion side of the longitudinal direction of the straight-tube lamp. Incidentally, as shown in the first and second preferred embodiments described above, the case of providing the even number of the lamp units is more preferable than the case of providing the odd number of the lamp units, because the equal number of the driving circuits of the lamp units can be disposed separately on the one end portion side and the other end portion side, respectively, so that the influence of non-uniformity of the brightness due to the brightness inclination can be decreased more so as to more easily make uniform the brightness.

Alternatively to the above description, the number of the straight-tube lamp portions included in the lamp unit can also be odd. However, as described in the first and second preferred embodiments, it is more preferable to provide N (N is an integer of 1 or more) pairs of the straight-tube lamp portions that are driven by driving signals from the driving circuits, which have equal amplitudes and phases that are opposite to each other, because it is possible to switch on each of the N pairs of the straight-tube lamp portions without grounding low voltage sides. Also, such provision of the N pairs of the straight-tube lamps is preferable, because an electronic component that is necessary for grounding the low voltage side, such as a ground terminal and a ground substrate, can be omitted, so that the structure of the lamp unit can be simplified, and the number of the members of the backlight device can be reduced. Moreover, the above description has provided the case of using the driving circuit that is provided with the two transformers arranged in each of the straight-tube lamp portions and the controlling circuit for controlling the transformers, which is illustrated in FIG. 3, but the driving circuit of the present invention is not limited to this, and may have a structure for driving to switch on the straight-tube lamp portions by using a single transformer constituted only of a primary wiring and a secondary wiring, for example. Also, it is possible to drive to switch on the two straight-tube lamp portions by a twin transformer that is provided with one primary wiring and two secondary wirings. Further, it is also possible to use a multiple light transformer that drives the three or more straight-tube lamp portions by one secondary wiring, or drive to switch on the three or more straight-tube lamp portions by using the secondary wirings in the same number.

Moreover, the above description has provided the case of structuring the one pair of the straight-tube lamp portions by using the pseudo U-shaped tube, but the one pair of the straight-tube lamp portions of the present invention are not limited to this, and for example, two straight-tube-shaped portions of one U-shaped lamp that is formed to have a U-shape as a whole can be used as the one pair of the straight-tube lamp portions. Incidentally, the case of using the pseudo U-shaped tube as described above is more preferable, because the straight-tube lamp portion having the excellent light utilizing efficiency and the more simple structure can be constituted more easily than the case of using the U-shaped lamp.

In the case of using the U-shaped lamp, since light fluxes gather to its U-shaped portion (bended portion) and an emitting light amount at the portion is larger than that at a straight-tube portion, it is required to attach a covering member for adjusting (decreasing) the light amount to the U-shaped portion so as to suppress the generation of the non-uniformity of the brightness of the U-shaped lamp, so that the optical utilizing efficiency may be decreased.

On the other hand, in the pseudo U-shaped tube, the respective straight-tube lamp portions can be disposed inside the case without providing the covering member as described above, so that the light from the respective straight-tube lamp portions can be utilized efficiently.

Moreover, the above description has provided the structure using the cold cathode-ray tube as each of the one pair of the straight-tube lamp portions, but each of the straight-tube lamp portions of the present invention is not limited to this, and other linear light sources such as heat cathode-ray tubes or the like can also be used as the straight-tube lamp portions. Incidentally, the case of using the cold cathode-ray tubes as described above is preferable, also because a slim and long linear light source can be structured and thicknesses and weights of the backlight device and the display device can be decreased easily.

Alternatively to the above description, mercury-free lamps such as xenon fluorescent lamps can also be used. In the case of using the lamp unit having such mercury-free lamps, it is also possible to structure long-life straight-tube lamp portions that are disposed in parallel with the gravitational direction.

The backlight device of the present invention and the display device using the same can easily make uniform the brightness of the light emitting surface even when using the longitudinal lamps, achieve excellent display performances, and are useful for the backlight device for the display portion with an increased screen size and the display device using the same.

While preferred embodiments of the present invention have been described above, it is to be understood that variations and modifications are within the scope and spirit of the present invention. The scope of the present invention, therefore, is to be determined solely by the following claims.

1-8. (canceled)

9. A backlight device comprising:
a plurality of straight-tube lamp portions; and
a lamp unit having a driving circuit that is connected with each of high voltage sides of the plurality of the straight-tube lamp portions and drives to switch on each of the straight-tube lamp portions; wherein
a plurality of the lamp units are arranged along a direction substantially perpendicular to a longitudinal direction of the straight-tube lamp portions; and
driving circuits of the plurality of the lamp units are disposed separately on one end portion side and another end portion side in the longitudinal direction of the straight-tube lamp portions.

10. The backlight device according to claim 9, wherein the number of the driving circuits provided on the one end portion side in the longitudinal direction of the straight-tube lamp portion is equal to the number of the driving circuits provided on the other end portion side in the longitudinal direction.

11. The backlight device according to claim 9, wherein the driving circuits of the plurality of the lamp units are disposed alternately on the one end portion side and the other end portion side in the longitudinal direction, in a direction substantially perpendicular to the longitudinal direction of the straight-tube lamp portions.

12. The backlight device according to claim 9, wherein the driving circuits on each of the one end portion side and the other end portion side in the longitudinal direction of the straight-tube lamp portion are disposed on a single substrate, respectively.

13. The backlight device according to claim 9, wherein the plurality of the straight-tube lamp portions include N, where N is an integer of 1 or more, pairs of the straight-tube lamp portions that are driven by driving signals from the driving circuits, which have equal amplitudes and phases that are opposite to each other.

14. The backlight device according to claim 13, wherein each of the pair of the straight-tube lamp portions comprises a high voltage side electrode that is connected with the driving circuit and a low voltage side electrode that is disposed facing to the high voltage side electrode, and the one pair of the straight-tube lamp portions include a pseudo U-shaped tube obtained by connecting the low voltage side electrodes of the one pair of the straight-tube lamp portions with each other via an external connection wiring.

15. The backlight device according to claim 9, wherein a cold cathode-ray tube is used for each of the plurality of the straight-tube lamp portions, and each of the straight-tube lamp portions is disposed so that a longitudinal direction thereof is substantially parallel with a direction substantially perpendicular to a gravitational direction.

16. A display device comprising a display portion and the backlight device according to claim 9, wherein the display portion is irradiated with light from the backlight device.
